(19) United States
(12) Patent Application Publication
(10) Pub. No.: US 2009/0218313 A1
(43) Pub. Date: Sep. 3, 2009

(54) METHOD FOR MANUFACTURING PATTERNED MAGNETIC RECORDING MEDIUM

(75) Inventors: Satomi Kajiwara, Matsumoto-shi (JP); Shuichi Shoji, Tokorozawa-shi (JP); Jun Mizuno, Kawagoe-shi (JP); Hidetoshi Shinohara, Kokubunji-shi (JP)

Correspondence Address: VENABLE LLP, P.O. BOX 34385, WASHINGTON, DC, 20043-9998, US

(73) Assignees: FUJI ELECTRIC DEVICE TECHNOLOGY CO., LTD., Shinagawa-ku (JP); WASEDA UNIVERSITY, Shinjuku-ku (JP)

(21) Appl. No.: 12/395,222

(22) Filed: Feb. 27, 2009

(30) Foreign Application Priority Data
Feb. 28, 2008 (JP) 2008-048744

(51) Int. Cl. G11B 5/84

(52) U.S. Cl. 216/22

(57) ABSTRACT

There is provided a method for manufacturing a patterned magnetic recording medium including a step of completely removing an etching resist on a magnetic layer 3, which is used for etching the magnetic layer 3, without deteriorating magnetic characteristics of the magnetic layer 3. The step of removing the etching resist used for etching the magnetic layer 3 includes the steps of irradiating the etching resist on the magnetic layer 3 or the first protective layer 4 with an excimer VUV laser under a reduced pressure and immersing the resist coating 5 remaining on the magnetic layer 3 or the first protective layer 4 into a resist removing agent solution to wash off the resist coating 5.

This application claims the benefit of Japanese Patent Application No. 2008-048744, filed Feb. 28, 2008, which is hereby incorporated by reference herein in its entirety.

### BACKGROUND OF THE INVENTION

1. Field of the Invention

The present invention relates to a method for manufacturing a patterned magnetic recording medium. The present invention more particularly relates to improvement of a method for removing a resist used to form a magnetic layer into tracked and/or dotted patterns.

2. Description of the Related Art

As next-generation magnetic recording media, there are expected patterned magnetic recording media wherein the magnetic layer is formed into tracked and/or dotted patterns, each of the patterns defining an information recording region.

As disclosed in Japanese Patent Laid-Open No. 2003-203301 and Japanese Patent Laid-Open No. 2003-123201, these patterned magnetic recording media allow not only normal information but also information specific to a recording medium such as administrator information of the information and operating information to be recorded in the defined information recording regions. These patterned magnetic recording media can contribute to the prevention of information leakage and the speed enhancement of operation or the like (Patent Documents 1 and 2).

To pattern a magnetic layer, it is possible to adopt a method for etching the magnetic layer using a patterned resist, which is conventionally adopted in the fields of electronic devices or the like. However, in order to remove a resist from a magnetic layer after etching, it is not possible to adopt dry-etching process or cleaning process with a removing agent solution disclosed in Japanese Patent Laid-Open No. 64-081949, which is used in the field of electronic devices or the like, as the sole means (Patent Document 3).

As means for solving this problem, Japanese Patent Laid-Open No. 2007-200422 proposes a method for manufacturing a patterned magnetic recording medium comprising the following steps of: forming a patterned resist coating on a magnetic layer by an imprint method, wherein the resist coating is decomposed to reduce its molecular weight through irradiation of an electromagnetic wave or electron beam; etching the magnetic layer using the patterned resist coating as a mask to reproduce the pattern in the magnetic layer; and irradiating the resist coating with an electromagnetic wave or electron beam to remove the resist coating from the magnetic layer (Patent Document 4).

### SUMMARY OF THE INVENTION

When a resist coating on a patterned magnetic layer is removed by a removing agent solution, which is used to remove the etching resist coating after forming a pattern of an electronic material in the field of electronic devices, there is apprehension that the patterned magnetic layer may be re-contaminated by residues of the removed resist, debris or the like accumulated in the removing agent solution.

On the other hand, when an etching resist coating is removed by dry-etching with an etching gas such as O₂, SF₆, or CF₄, magnetic substances contained in the magnetic layer may be altered by the action of the employed etching gas or plasma to bring about alteration in the magnetic characteristics of the magnetic layer. In some cases, the magnetic characteristics of the magnetic layer may deteriorate.

The method for removing a resist coating disclosed in Japanese Patent Laid-Open No. 2007-200422 has restrictions on available resist materials. Furthermore, additional heat treatment is required for completely removing the resist with the reduced molecular weight through irradiation of an electromagnetic wave or electron beam. Such heat treatment may also cause alteration of the magnetic layer or variation (deterioration) of the magnetic characteristics of the magnetic layer.

Furthermore, when the resist coating on the magnetic layer is not completely removed to remain the resist coating residue on the magnetic layer, it is difficult to achieve stable flight of the magnetic head. As a result, magnetic signals from the magnetic recording medium can no longer be stably detected. In some cases, the magnetic head itself may collide with the remaining resist and the magnetic head may be broken.

It is an object of the present invention to provide a method for manufacturing a patterned magnetic recording medium including a step of completely removing a resist coating from a magnetic layer used for etching the magnetic layer without deteriorating magnetic characteristics of the magnetic layer.

As a result of making every effort to attain the above-described object, the present inventors have discovered that it is possible to completely remove a resist from a magnetic layer without any damage to the magnetic layer and also prevent accumulation of contaminants in a removing agent solution and recontamination of the magnetic layer by the contaminants. The present invention comprises the following steps of: irradiating a resist coating on the magnetic layer with an excimer VUV laser under a reduced pressure to remove most of the resist coating; and washing off the resist coating remaining on the magnetic layer with a resist removing agent solution consists mainly of dimethylformamide (DMF)

The method for manufacturing a patterned magnetic recording medium according to the present invention comprises the steps of:

(1) applying an etching resist onto a laminate including a substrate, magnetic layer and first protective layer in this order to form a resist coating;
(2) patterning the resist coating to form an etching pattern;
(3) etching the magnetic layer and first protective layer along the etching pattern to form a patterned magnetic layer and a patterned first protective layer;
(4) irradiating an excimer VUV laser onto the resist coating; and
(5) washing off the resist coating with a resist removing agent solution.

The present invention may further comprise the step of (6) forming a second protective layer on the patterned magnetic layer, subsequently to the above-described step (5).

Furthermore, the method for manufacturing a patterned magnetic recording medium according to the present invention also includes an aspect of method for manufacturing a patterned magnetic recording medium comprising the steps of:

(1′) applying an etching resist onto a laminate including a substrate and magnetic layer in this order to form a resist coating;
(2′) patterning the resist coating to form an etching pattern;
(3′) etching the magnetic layer along the etching pattern to form a patterned magnetic layer;
(4′) irradiating the resist coating with an excimer VUV laser;
(5′) washing off the resist coating with a resist removing agent solution; and
(6′) forming a protective layer on the patterned magnetic layer.

The excimer VUV laser is preferably a xenon excimer VUV laser that emits VUV rays having a wavelength of 172 nm±15 nm.

The resist removing agent solution is preferably a resist removing agent solution consists mainly of dimethylformamide (DMF).

The above-described steps (2) and (2′) is preferably achieved by pressing the resist coating with a mold having a desired pattern and hardening the resist coating.

The present invention involves the step of irradiating the resist coating on the magnetic layer or protective layer with an excimer VUV laser under a reduced pressure, and thereby causes the resist coating to be easily dissolved into the resist removing agent solution through wash-off step. This is because irradiating with the excimer VUV laser reduces molecular weight of the resist coating. Therefore, it is possible to completely remove the resist coating from the magnetic layer or protective layer and reduce the deterioration of magnetic characteristics of the magnetic layer during the removal step to a minimum (see FIG. 2). Furthermore, recontamination of the magnetic layer with the resist removing agent solution can also be prevented, since the accumulation of the solid content in the resist removing agent solution is also reduced to a minimum. Therefore, when a magnetic recording medium manufactured in accordance with the present invention is used in a hard disk apparatus, it is possible to accomplish stable flight of the magnetic head without the magnetic head colliding with the remaining resist. As a result, the magnetic recording medium manufactured in accordance with the present invention can provide stable detection of magnetic signals.

Further features of the present invention will become apparent from the following description of exemplary embodiments (with reference to the attached drawings).

### BRIEF DESCRIPTION OF THE DRAWINGS

FIG. 1 is a process chart showing an embodiment of a method for manufacturing a patterned magnetic recording medium of the present invention;

FIG. 2 is a graph showing a magnetization curve of the magnetic recording medium before and after patterning in Example 1, measured using a magneto-optical effect measuring apparatus (Kerr);

FIG. 3 is a graph showing a magnetization curve of the magnetic recording medium before and after patterning in Comparative Example 1, measured using a Kerr; and

FIG. 4 is a graph showing a magnetization curve of the magnetic recording medium before and after patterning in Comparative Example 2, measured using a Kerr.

### DESCRIPTION OF THE EMBODIMENTS

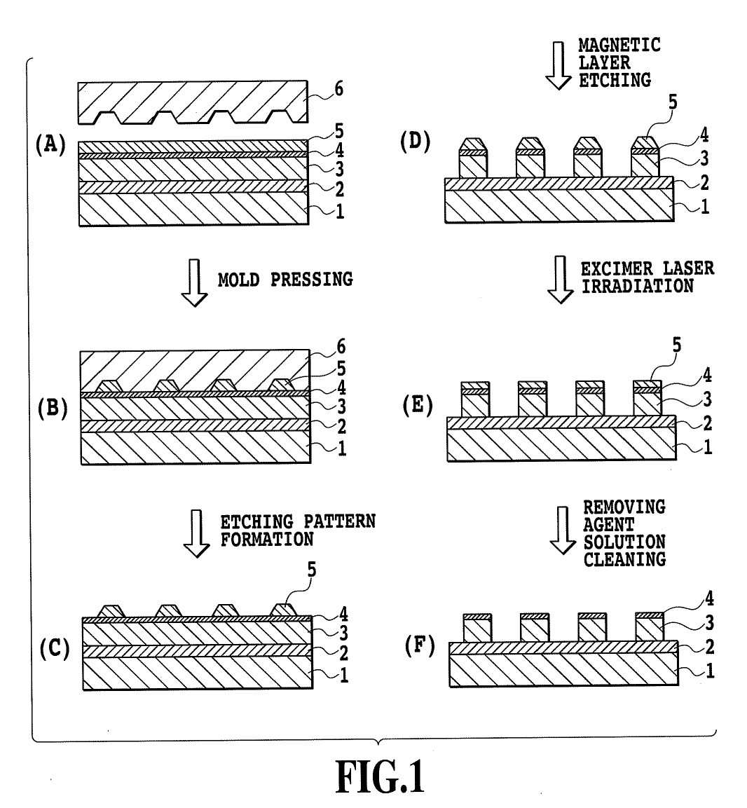

As shown in FIG. 1, the present invention comprises the steps of:

(1) applying an etching resist onto a laminate including a substrate 1, a base layer 2, a magnetic layer 3 and a first protective layer 4 in this order to form a resist coating 5;
(2) patterning the resist coating 5 to form an etching pattern;
(3) etching the magnetic layer 3 and first protective layer 4 along the etching pattern to form a patterned magnetic layer and a patterned first protective layer;
(4) irradiating the resist coating 5 with an excimer VUV laser; and
(5) washing off the resist coating 5 with a resist removing agent solution.

The substrate 1 used in the present invention includes a glass substrate, a non-magnetic metal substrate such as aluminum, and a plastic substrate. Before the magnetic layer 3 is deposited, the base layer 2 may be optionally formed on the substrate 1 of the present invention.

The magnetic layer 3 patterned in the present invention includes ferromagnetic metal such as Fe, Co, Ni, or metal oxide magnetic substance such as MnO, NiO, CoO. The magnetic layer 3 can be manufactured using an ordinary method.

The first protective layer 4 patterned in the present invention is formed of an inorganic material, carbonaceous material or the like. A CVD method (including thermal CVD method and plasma CVD method), vacuum deposition method or the like can be used to form the first protective layer 4. The first protective layer 4 is preferably made of a carbonaceous material formed using a plasma CVD method.

Step (1) is a step of forming the unhardened resist coating 5 by applying a resist material or a solution containing the resist material onto the first protective layer 4 formed on the magnetic layer 3 laminated on the substrate 1. Step (1) is performed by a known method such as a spin coat method, dipping method, spray method or ink jet method. If necessary, the resist coating 5 may be heated to 80-150° C. to remove the solvent.

Any one of thermosetting and photosetting resists commonly used to an etching pattern formation in the art may be used as the resist material of the present invention. Examples of the resist materials include thermosetting resists such as mr-I-8010E (product name, manufactured by Microresist Technology GmbH) and photosetting resists such as PAK-01 (product name, manufactured by Toyo Gosei Co., Ltd.), AMONIL (product name, manufactured by AMO Gmbh), NIF-1 (product name, manufactured by Asahi Glass Co., Ltd.).

In Step (2) the unhardened resist coating 5 formed in the preceding step is hardened in a pattern shape so as to obtain a desired etching pattern. A resist patterning method widely known to those skilled in the art can be used for the etching pattern forming step. For example, an imprint method is preferable, which comprises pressing a mold 6 having a desired pattern against the unhardened resist coating, transferring the pattern of the mold 6 to the resist coating 5 and hardening the resist coating 5.

When a thermosetting resist is used as the resist material in the imprint method, it is possible to form an etching pattern by pressing the mold 6 heated to a predetermined temperature against the resist coating 5 and hardening the patterned resist. When a photosetting resist is used, an etching pattern is formed by pressing the light transmissive mold 6 such as quartz mold against the resist coating 5, irradiating active rays through the mold 6 and hardening the patterned resist.

Step (3) is a step of etching the first protective layer 4 and the magnetic layer 3 along the etching pattern of the hardened resist formed in the preceding step. Example of the etching method for the magnetic layer 3 and the first protective layer 4 include, but are not limited, dry-etching using O₂, CF₄, SF₆, Ar or the like, preferably. Although the resist coating 5 that remains at the bottom of the etching pattern does not constitute any barrier to etching of the first protective layer 4 and the magnetic layer 3, the remaining coating is usually removed prior to etching using an O₂-RIE method or the like.

Step (4) is a step of irradiating the resist coating 5 on the first protective layer 4 with an excimer VUV laser under a reduced pressure, dissociating most of bonds in the resist coating 5 to reduce their molecular weights and remove part of the resist coating 5 from the first protective layer 4.

The excimer VUV laser is a laser that uses excimer as an active medium, and the excimer is produced by application of pulse discharge or irradiation of an electron beam to a rare gas such as argon, krypton and xenon; halogen such as fluorine, chlorine; or a mixed gas thereof. The oscillating wavelength of the excimer VUV laser depends on the type of gas used.

In particular, the xenon excimer VUV laser has a high capacity of bond dissociation of organic compounds and reducing their molecular weights, since a xenon excimer VUV laser using xenon has a high light emission efficiency of approximately 20% and a range of light-emitting wavelength concentrated on 172 nm±15 nm. Furthermore, oxygen has a large absorption coefficient within a range of light-emitting wavelength of the xenon excimer VUV laser. Therefore, when the xenon excimer VUV laser is irradiated into an atmosphere where a trace quantity of oxygen exists, it is possible to generate active atomic oxygen or ozone at a high concentration and decompose organic compounds into carbon dioxide and water. From above-described points, the xenon excimer VUV laser is suitable as a laser for removing of the resist coating 5.

The excimer VUV laser is irradiated under a reduced pressure, preferably under a reduced pressure of 10 KPa (100 mbar) or less, or more preferably under an atmosphere of 10 KPa or less with the existence of oxygen, normally at an irradiation distance of 5 mm or less, or preferably 3 mm or less for on the order of 10 to 15 minutes.

Step (5) is a step of washing off residues of the resist coating 5 on the first protective layer 4 and/or decomposed products thereof using a resist removing agent solution. The resist coating 5 remaining on the first protective layer 4 can be completely and easily removed through washing off with the resist removing agent solution, since the molecular weight of the resist coating 5 has been reduced by irradiation of the excimer VUV laser. Moreover, the resist coating 5 is practically completely dissolved in the resist removing agent solution and insoluble removed materials are never accumulated, since the resist coating 5 not only has been subjected to molecular weight reduction but also remain only a small amount for removal. As a result, recontamination of the magnetic layer 3 by the resist removing agent solution is also prevented.

A commercially available resist removing agent solution used for removal of conventional resists may be used as the resist removing agent solution used in the present invention. Especially dimethylformamide (DMF) is preferable in that it is an aprotic polar solvent that can dissolve various inorganic/organic compounds including liquid, gas, ionic compounds and covalent compounds. For example, a resist removing agent solution consists mainly of DMF as described in Japanese Patent Laid-Open No. 64-081949 can be used.

The present invention may further comprise the step of (6) forming a second protective layer (not shown) on the patterned magnetic layer 3. Step (6) is commonly carried out after step (5). Step (6) is a step of further coating the patterned first protective layer 4 and the patterned magnetic layer 3 with a second protective layer, which is made of an inorganic material or carbonaceous material. A CVD method (including thermal CVD method and plasma CVD method), vacuum deposition method or the like can be adopted as a method for forming the second protective layer. A carbonaceous protective film is preferably formed using a plasma CVD method as the second protective layer.

The patterned magnetic recording medium in accordance with the present invention can be created as described above.

The method for manufacturing a patterned magnetic recording medium by etching a laminate including the magnetic layer 3 and the first protective layer 4 has been explained so far. The present invention further includes a modified embodiment in which the first protective layer 4 is not employed. That is, the modified embodiment of the present invention comprises the steps of:

(1′) applying an etching resist onto a laminate including the substrate 1, base layer 2 and magnetic layer 3 in this order to form the resist coating 5;
(2′) patterning the resist coating to form an etching pattern;
(3′) etching the magnetic layer 3 along the etching pattern to form a patterned magnetic layer;
(4′) irradiating the resist coating 5 with an excimer VUV laser;
(5′) washing off the resist coating 5 with a resist removing agent solution; and
(6′) forming a protective layer (corresponds to the second protective layer in step (6)) on the patterned magnetic layer. Steps (1′) to (6′) in this modified embodiment can be carried out in the same way as in aforementioned steps (1) to (6) except for the absence of the first protective layer 4.

### EXAMPLES

### Example 1

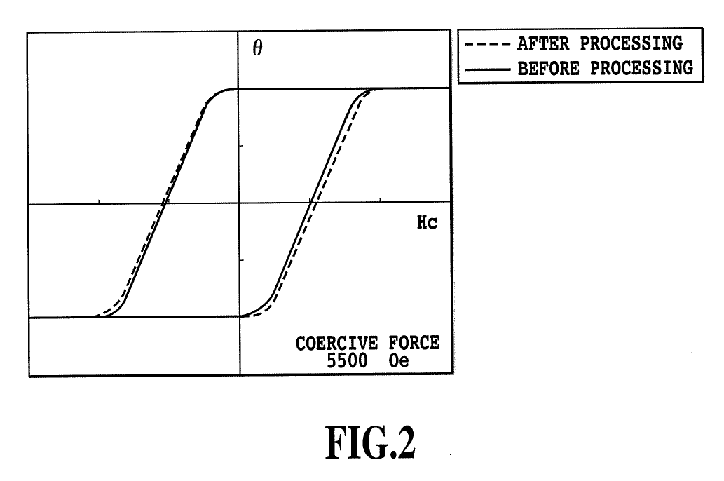

Onto 2.5 inch glass substrate 1 was laminated base layer 2 of a thickness of 30 nm, magnetic layer 3 of a thickness of 20 nm which consists of CoCrPtSiO₂, and carbon first protective layer 4 of a thickness of 3 nm, to create a magnetic recording medium. The recording medium had the magnetic characteristics shown by the solid line in FIG. 2. Next, the thermosetting resist mr-I-8010E (product name, manufactured by Microresist Technology GmbH) was applied on the first protective layer 4 by spin coating to form the resist coating 5 of a thickness of 100 nm.

The formed resist coating 5 was pressed with the nickel mold 6 having an 80 nm wide, 60 nm deep tracked pattern heated to 180° C., under a pressure of 100 MPa (1000 bar) for 30 seconds in a press apparatus, and thereby hardening the thermosetting resist to form an etching pattern on the resist coating 5.

The resist coating 5 remaining at the bottom of the etching pattern was removed using an O₂-RIE method. Subsequently, the carbon first protective layer 4 and the magnetic layer 3 were etched using argon milling.

A 172 nm VUV ray emitted from a xenon excimer VUV laser was irradiated onto the resist coating 5 on the first protective layer 4 under oxygen containing atmosphere having a pressure of 10 KPa (100 mbar) at an irradiation distance of 1.8 mm for 10 minutes. Next, the substrate 1 was washed off by immersing in a DMF solution for five minutes.

The surface of the first protective layer 4 before and after the washing off step using a DMF solution was measured using a Fourier transform infrared spectrometer (FT-IR). As a result, a trace of remaining organic compound was detected on the surface of the first protective layer 4 before the cleaning processing, whereas the existence of no organic compound was detected on the surface of the first protective layer 4 after the washing off step. Thus, it has been confirmed that the resist coating 5 was completely removed.

The patterned magnetic recording medium obtained above had the tracked magnetic layer 3 having a pattern width of 80 nm, pattern spacing of 80 nm and pattern height of 20 nm. The magnetic characteristic of the patterned magnetic recording medium was measured using a magneto-optical setting measuring apparatus (Kerr). The result is shown in FIG. 2. The result is shown by dotted lines in FIG. 2. The patterned magnetic recording medium of the present example kept the magnetic characteristic of the magnetic recording medium before patterning.

The resultant patterned magnetic recording medium was installed in the magnetic apparatus, and subjected to repeated reading and writing of information. Even after 10,000 repetitions, stable magnetic signals were detected from the patterned magnetic recording medium.

### Example 2

A patterned magnetic recording medium was manufactured under the same conditions as those of Example 1 except in that the irradiation atmosphere of the excimer VUV laser in Example 1 was changed to a nitrogen atmosphere having a pressure of 6 KPa (60 mbar) and the irradiation distance was changed to 2.7 mm in the step of removing the resist coating 5.

An FT-IR analysis of the resultant recording medium surface after the washing off step using a DMF solution confirmed that the resist on the first protective layer 4 was completely removed. Furthermore, it was confirmed that the magnetic characteristic of the magnetic recording medium measured using a Kerr was kept before and after patterning as Example 1.

### Comparative Example 1

The irradiation of 172 nm VUV rays emitted from the xenon excimer VUV laser in Example 1 was changed to the irradiation of ultraviolet rays having a wavelength range of 129 to 450 nm emitted from a UV cleaning apparatus. Next, instead of performing washing off step using a DMF solution, the substrate 1 was heated at 200° C. for 40 minutes in a vacuum oven to manufacture a patterned magnetic recording medium.

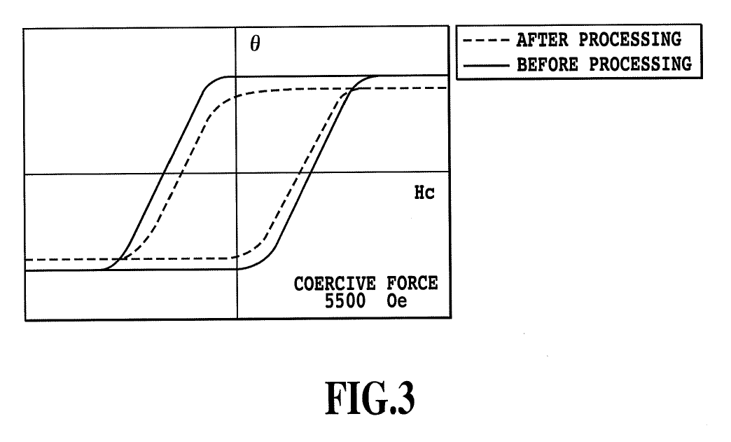

As a result of an FT-IR analysis of the resultant magnetic recording medium surface, residues of the resist coating were detected on the first protective layer 4. The magnetic characteristic of the magnetic recording medium measured using a Kerr was changed from the magnetic characteristics before patterning shown by solid lines in FIG. 3 to those shown by dotted lines in the same figure. The saturation magnetization and coercive force of the magnetic recording medium in this comparative example slightly deteriorated after the resist removing step. This shows that heat treatment after irradiation of ultraviolet rays caused the magnetic layer to deteriorate.

The resultant patterned magnetic recording medium was installed in a magnetic recording/reading apparatus. Repeated writing and reading of information was carried out. As a result, problems sometimes occurred with reading/writing of magnetic recording signals. After about 10,000 repetitions of reading/writing, the magnetic recording/reading apparatus became impossible to perform further reading/writing.

### Comparative Example 2

A patterned magnetic recording medium was manufactured by performing processing similar to that in Example 1 except in that the resist was removed by O₂ plasma processing instead of the resist coating removing processing by irradiating the excimer VUV laser and then washing off with DMF solution in Example 1.

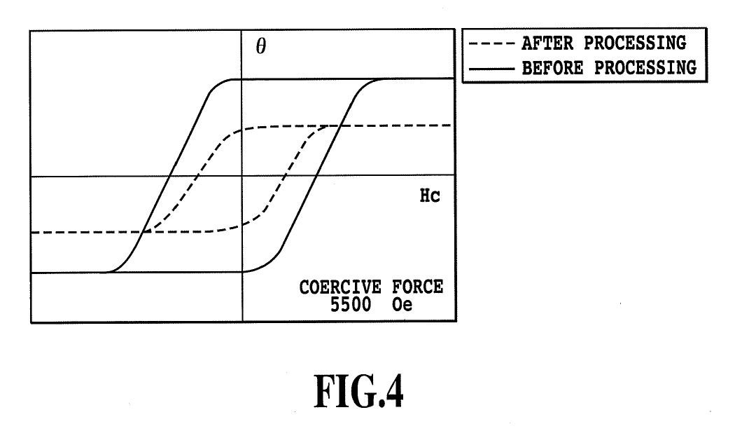

The magnetic characteristics of the magnetic recording medium in this comparative example were measured using a Kerr before and after patterning step. The magnetic characteristic before the patterning step shown by solid lines in FIG. 4 is drastically changed to those shown by dotted lines. Thus, a degradation of the magnetic layer 3 was observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### CITATION LIST

### Patent Literature

[Patent Document 1] Japanese Patent Laid-Open No. 2003-203301
[Patent Document 2] Japanese Patent Laid-Open No. 2003-123201
[Patent Document 3] Japanese Patent Laid-Open No. 64-081949
[Patent Document 4] Japanese Patent Laid-Open No. 2007-200422

What is claimed is:

1. A method for manufacturing a patterned magnetic recording medium, comprising the steps of:
(1) applying an etching resist onto a laminate including a substrate, magnetic layer and first protective layer in this order to form a resist coating;
(2) patterning the resist coating to form an etching pattern;
(3) etching the magnetic layer and first protective layer along the etching pattern to form a patterned magnetic layer and a patterned first protective layer;
(4) irradiating an excimer VUV laser onto the resist coating; and
(5) washing off the resist coating with a resist removing agent solution.

2. The method for manufacturing a patterned magnetic recording medium according to claim 1, wherein the excimer VUV laser is a xenon excimer VUV laser that emits VUV rays having a wavelength of 172 nm±15 nm.

3. The method for manufacturing a patterned magnetic recording medium according to claim 1, wherein the resist removing agent solution consists mainly of dimethylformamide (DMF).

4. The method for manufacturing a patterned magnetic recording medium according to claim 1, wherein the step (2) is carried out by pressing a mold having a desired pattern and hardening the resist coating.

5. The method for manufacturing a patterned magnetic recording medium according to claim 1, further comprising (6) a step of forming a second protective layer on the patterned magnetic layer.

6. A method for manufacturing a patterned magnetic recording medium, comprising the steps of:
(1′) applying an etching resist onto a laminate including a substrate and magnetic layer in this order to form a resist coating;
(2′) patterning the resist coating to form an etching pattern;
(3′) etching the magnetic layer along the etching pattern to form a patterned magnetic layer;
(4′) irradiating the resist coating with an excimer VUV laser;
(5′) washing off the resist coating with a resist removing agent solution; and
(6′) forming a protective layer on the patterned magnetic layer.

7. The method for manufacturing a patterned magnetic recording medium according to claim 6, wherein the excimer VUV laser is a xenon excimer VUV laser that emits VUV rays having a wavelength of 172 nm±15 nm.

8. The method for manufacturing a patterned magnetic recording medium according to claim 6, wherein the resist removing agent solution consists mainly of dimethylformamide (DMF).

9. The method for manufacturing a patterned magnetic recording medium according to claim 6, wherein the step (2′) is carried out by pressing a mold having a desired pattern and hardening the resist coating.
